(19) United States
(12) Patent Application Publication
(10) Pub. No.: US 2007/0285155 A1
(43) Pub. Date: Dec. 13, 2007

(54) Discrimination Circuit, Gain Adjustment Circuit, Signal Processing Circuit, and Electric Device

(76) Inventors: Shinji Yano, Kyoto (JP); Hidetoshi Nishikawa, Kyoto (JP)

Correspondence Address: FISH & RICHARDSON P.C., P.O. BOX 1022, MINNEAPOLIS, MN, 55440-1022, US

(21) Appl. No.: 11/660,419

(22) PCT Filed: Jul. 11, 2005
(86) PCT No.: PCT/JP05/12738

§ 371 Date: Feb. 16, 2007

(30) Foreign Application Priority Data
Aug. 18, 2004 (JP) 2004-238640
Aug. 26, 2004 (JP) 2004-246161

(51) Int. Cl. H04N 5/00

(52) U.S. Cl. 327/558; 348/E05.001

(57) ABSTRACT

A discrimination circuit of the present invention checks whether a received signal is noise or a signal that is repeated with interposed rest time periods, and is provided with a low-pass filter that has a cut-off frequency that is lower than the frequency of the noise but higher than the reciprocal of a total period of one frame of the signal that is repeated with interposed rest time periods and the rest time period, and a judgment circuit that judges, according to an output of the low-pass filter, whether the received signal is noise or a signal that is repeated with interposed rest time periods. With this configuration, it is possible to discriminate between noise and a signal that is repeated with interposed rest time periods, and achieve miniaturization.

### TECHNICAL FIELD

The present invention relates to a discrimination circuit that discriminates between noise and a signal that is repeated with interposed rest time periods, and to a signal processing circuit and an electric device provided with such a discrimination circuit. The present invention relates also to a gain adjustment circuit that adjusts a gain of a variable gain unit (a variable gain amplifier or a variable gain attenuator) that inputs a signal that is repeated with long interposed rest time periods, and to a signal processing circuit and an electric device provided with such a gain adjustment circuit.

### BACKGROUND ART

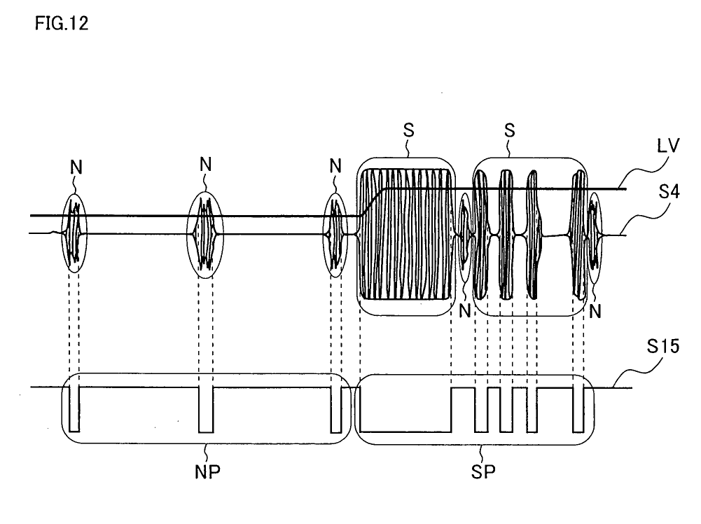

A photoreceiver circuit that receives an optical signal transmitted from an infrared remote control transmitter will be described as an example of a conventional signal processing circuit. FIG. 11 shows a typical circuit configuration of the conventional photoreceiver circuit.

The conventional photoreceiver circuit shown in FIG. 11 is provided with a photodiode 1, a current-voltage conversion circuit 2, an amplifier 14, a band-pass filter 4, a detection circuit 15, a pulse-modulated-signal demodulation circuit 7, a transistor 8, a pull-up resistor 9, and an output terminal 10. This conventional photoreceiver circuit is not provided with a discrimination circuit that discriminates between noise and a signal that is repeated with interposed rest time periods.

An optical signal transmitted from an infrared remote control transmitter (unillustrated) is converted into a current signal by the photodiode 1. The current signal is then converted into a voltage signal by the current-voltage conversion circuit 2, is then amplified by the amplifier 14, and is then inputted to the band-pass filter 4.

The band-pass filter 4 allows only a frequency component of the received signal in a predetermined range to pass therethrough, and sends it to the detection circuit 15. The output signal of the band-pass filter 4 behaves as shown in FIG. 12, for example. The output signal S4 of the band-pass filter 4 shown in FIG. 12 includes noise N at a frequency of 100 to 120 Hz that is produced when a fluorescent lamp is lit and a signal S based on the optical signal transmitted from the infrared remote control transmitter.

The detection circuit 15 judges whether or not the output signal S4 of the band-pass filter 4 is higher than the detection level LV shown in FIG. 12. If the output signal S4 of the band-pass filter 4 is judged to be higher than the detection level LV, the detection circuit 15 generates a signal S15 that takes a Low level; if the output signal S4 of the band-pass filter 4 is judged not to be higher than the detection level LV, the detection circuit 15 generates a signal S15 that takes a High level, and then outputs the resultant signal to the pulse-modulated-signal demodulation circuit 7. When the output signal S4 of the band-pass filter 4 is found to be higher than a predetermined level, the detection circuit 15 switches the detection level LV from a first predetermined level to a second predetermined level (>a first predetermined level); when the output signal S4 of the band-pass filter 4 is found to have been equal to or lower than a predetermined level for a predetermined time, the detection circuit 15 switches the detection level LV from the second predetermined level to the first predetermined level.

The output signal S15 of the detection circuit 15 includes a noise pulse NP based on the noise N at a frequency of 100 to 120 Hz that is produced when the fluorescent lamp is lit and a signal pulse SP based on the signal S based on the optical signal transmitted from the infrared remote control transmitter.

The pulse-modulated-signal demodulation circuit 7 demodulates the pulse-modulated signal, the output signal S15 of the detection circuit 15, and outputs the demodulated signal to the base of the transistor 8. Here, the emitter of the transistor 8 is grounded, the collector of the transistor 8 is connected to the pull-up resistor 9, and the output terminal 10 is connected to a node where the collector of the transistor 8 and the pull-up resistor 9 are connected together. Thus, the signal outputted from the pulse-modulated-signal demodulation circuit 7 is inverted and then outputted from the output terminal 10.

Patent Document 1: JP-A-2001-502147

### DISCLOSURE OF THE INVENTION

### Problems to be Solved by the Invention

The signal outputted from the output terminal 10 is inputted to a microcomputer, for example. If this microcomputer can ignore (remove or cancel, for example) a pulse based on a noise pulse NP, a malfunction does not occur. However, a malfunction may occur if the microcomputer cannot ignore (remove or cancel, for example) a pulse based on a noise pulse NP.

To solve this problem, a discrimination circuit that discriminates between noise and a signal that is repeated with interposed rest time periods may be provided so that, when noise is detected by the discrimination circuit, a gain of an amplifier 13 is reduced. Although Patent Document 1 discloses such a method of discriminating between noise and a signal that is repeated with interposed rest time periods, the method disclosed in Patent Document 1 requires a circuit provided with a counter and the like. This makes miniaturization of the circuit impossible.

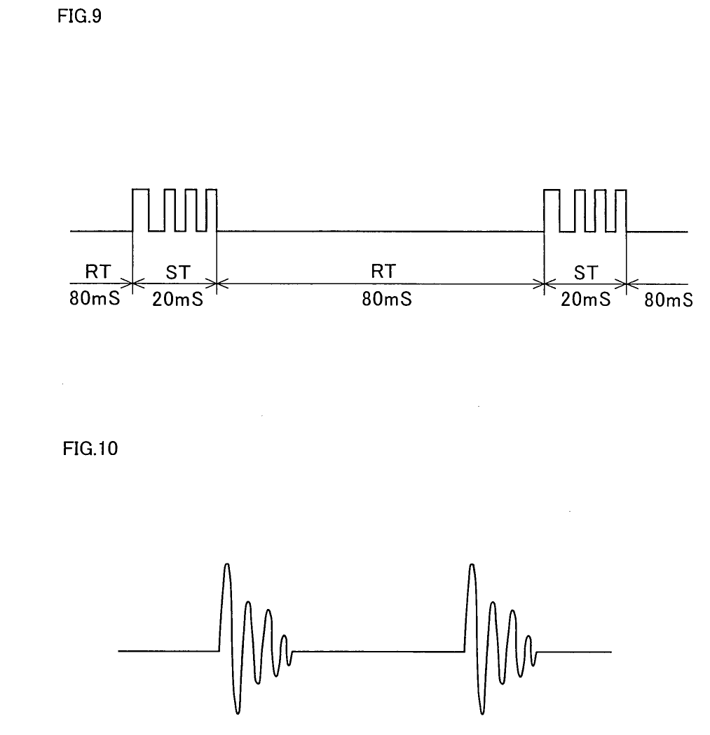

Some conventional signal processing circuits (for example, photoreceiver circuits that receive an optical signal transmitted from an infrared remote control transmitter aimed at foreign manufacturers) process a signal that is repeated with long interposed rest time periods RT (two to four times as long as a signal-generating time period ST) as shown in FIG. 9.

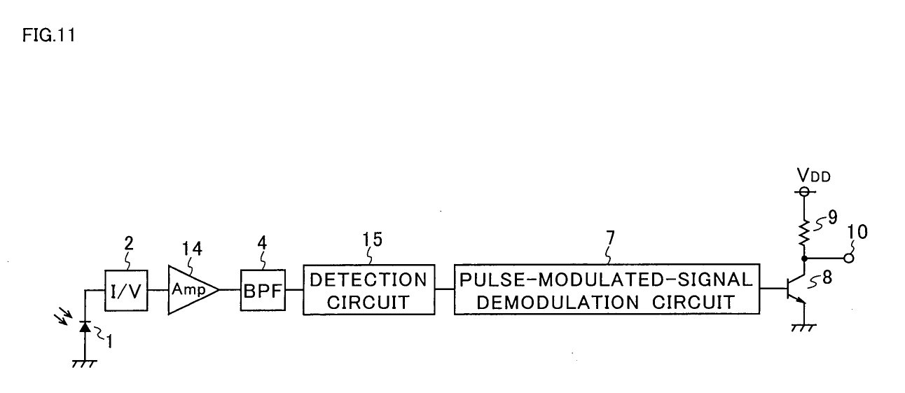

The signal processing circuit that processes a signal that is repeated with long interposed rest time periods RT as shown in FIG. 9 has a signal recognizer that recognizes a signal by using a signal recognition level V_{T}signal. In the signal processing circuit that processes a signal that is repeated with long interposed rest time periods RT as shown in FIG. 9, if periodic noise as shown in FIG. 10 occurs when no signal is produced and the level of the noise is higher than the signal recognition level V_{T}signal, the noise is recognized as a signal by the signal recognizer, undesirably contributing to a malfunction.

To prevent a malfunction, discrimination means that discriminates between a signal and noise and that separately detects them may be provided so that, when noise is detected by the discrimination means, a gain of a variable gain unit provided in the stage preceding the signal recognizer is reduced so as to prevent the level of the noise from being higher than the signal recognition level V_{T}signal.

Here, an example of discrimination means that discriminates between a signal and noise and that separately detects them is seen in Patent Document 1. The technology disclosed in Patent Document 1 is a method of discriminating between a signal that is repeated with long interposed rest time periods Tp and noise, wherein, if a rest time period Td (for example, 24 mS) that is longer than a period of noise but shorter than a rest time period Tp occurs during a check time period Tcheck (for example, 96 mS), it is recognized to be a signal; if a rest time period Td does not occur during a check time period Tcheck, it is recognized to be noise.

However, when the technology disclosed in Patent Document 1 is used, checking is performed as to whether it is a signal or noise every check time periods Tcheck. This slows down the gain adjustment rate. For instance, assume that there are 128 levels of gain, and a signal shown in FIG. 9 is processed. Then, the transition from the minimum gain to the maximum gain requires 12.7 S (=127×100 mS). Likewise, the transition from the maximum gain to the minimum gain requires 12.7 S (=127×100 mS).

A first object of the present invention is to provide a discrimination circuit that can discriminate between noise and a signal that is repeated with interposed rest time periods and that can achieve miniaturization, and a signal processing circuit and an electric device provided with such a discrimination circuit. A second object of the present invention is to provide a gain adjustment circuit that achieves a high gain adjustment rate, and a signal processing circuit and an electric device provided with such a gain adjustment circuit.

### Means for Solving the Problem

To achieve the first object, according to the present invention, a discrimination circuit checks whether a received signal is noise or a signal that is repeated with interposed predetermined time periods, and is provided with a low-pass filter that has a cut-off frequency that is lower than a frequency of the noise but higher than a reciprocal of a total period of one frame of the signal that is repeated with interposed predetermined time periods and the predetermined time period, and a judgment circuit that judges, according to an output of the low-pass filter, whether the received signal is noise or a signal that is repeated with interposed predetermined time periods.

With this configuration, if the received signal is noise, the low-pass filter outputs a signal that maintains a High level; if the received signal is a signal that is repeated with interposed predetermined time periods, the low-pass filter outputs a signal in which a High level period corresponding to one frame of the signal that is repeated with interposed predetermined time periods and a Low level period corresponding to the predetermined time period appear alternately. This makes it possible to discriminate between noise and a signal that is repeated with interposed predetermined time periods based on the output waveform of the low-pass filter. Moreover, the discrimination circuit configured as described above discriminates between noise and a signal that is repeated with interposed predetermined time periods based on the output waveform of the low-pass filter. This eliminates the need to provide a counter or the like, and helps achieve miniaturization of the circuit.

To achieve the first object, a signal processing circuit according to the present invention is provided with a variable gain unit (a variable gain amplifier or a variable gain attenuator), a discrimination circuit that receives a signal based on an output of the variable gain unit and checks whether the received signal is noise or a signal that is repeated with interposed predetermined time periods, and a gain control circuit that controls a gain of the variable gain unit according to a check result of the discrimination circuit. Used as the discrimination circuit here is the discrimination circuit described above. The signal processing circuit according to the present invention may be provided with a band-pass filter that receives a signal based on an output signal of the variable gain unit, the discrimination circuit may receive a signal based on an output signal of the band-pass filter, and the signal processing circuit may be provided with a signal processor that processes a signal based on an output signal of the band-pass filter. Moreover, to achieve the first object, an electric device according to the present invention is provided with a signal processing circuit according to the present invention, the signal processing circuit having one of the configurations described above.

To achieve the second object, according to the present invention, a gain adjustment circuit is provided with a comparison circuit that compares a received signal with a predetermined noise-level voltage, an addition/subtraction value calculation circuit that outputs, according to a signal based on an output of the comparison circuit, a predetermined addition value or a predetermined subtraction value, a gain register that temporarily stores a gain value, an adder-subtractor that performs an operation on the predetermined addition value or the predetermined subtraction value outputted from the addition/subtraction value calculation circuit and the gain value outputted from the gain register, and outputs an operation result to the gain register as the gain value, and a gain controller that adjusts a gain of an external variable gain unit according to a gain value outputted from the gain register (hereinafter referred to as a first configuration).

With this configuration, unlike the technology disclosed in Patent Document 1, instead of performing checking as to whether it is a signal or noise every check time periods Tcheck, gain adjustment is performed without checking whether the received signal is a signal or noise. This helps increase a gain adjustment rate.

The gain adjustment circuit having the first configuration may be provided with an oscillator that generates a clock signal having a predetermined period and a set-reset flip-flop that receives an output of the comparison circuit at a set terminal thereof, that receives the clock signal at a reset terminal thereof, and that sends output data to the addition/subtraction value calculation circuit. Here, the gain register may perform clock operation based on the clock signal.

With this configuration, by setting the predetermined period to a period that is longer than a period of noise but shorter than a rest time period RT shown in FIG. 9, it is possible to increase a gain adjustment rate both in increasing and decreasing a gain.

Moreover, the gain adjustment circuit having the first configuration may be provided with an oscillator that generates a clock signal, a first counter that receives an output of the comparison circuit at a reset terminal thereof, and, unless reset, outputs a pulse at a first time interval, and a second counter that receives an output of the first counter at a reset terminal thereof, and, unless reset, outputs a pulse at a second time interval. Here, the gain register, the first counter, and the second counter may operate based on the clock signal. Upon receiving a pulse output from the second counter, the addition/subtraction value calculation circuit may output a predetermined subtraction value, and, upon receiving a pulse output from the first counter, the addition/subtraction value calculation circuit may output a predetermined addition value.

With this configuration, by setting the first time interval to an interval that is longer than a period of noise but shorter than a rest time period RT shown in FIG. 9 and by setting the second time interval to an interval that is equal to the sum of a signal-generating time period ST and a rest time period RT, it is possible to increase a gain adjustment rate in increasing a gain.

To restore the desired gain during the rest time period RT shown in FIG. 9 even when the gain of the external variable gain unit drops to an undesired level, or to further increase the gain adjustment rate in increasing a gain, in the gain adjustment circuit having one of the configurations described above, it is preferable that the predetermined addition value be larger than the absolute value of the predetermined subtraction value.

To suppress the variation of a gain value, the gain adjustment circuit having one of the configurations described above may be provided with a storage portion that temporarily stores a previous predetermined addition value or predetermined subtraction value. Here, if the previous predetermined addition value or predetermined subtraction value stored in the storage portion is not equal to the predetermined addition value or predetermined subtraction value outputted from the addition/subtraction value calculation circuit, the adder-subtractor may output the gain value outputted from the gain register, as it is, as a gain value to the gain register without performing an operation on the predetermined addition value or the predetermined subtraction value outputted from the addition/subtraction value calculation circuit and the gain value outputted from the gain register.

To achieve the second object, according to the present invention, a signal processing circuit is provided with a variable gain unit, a signal processor that processes a signal based on an output of the variable gain unit, and a gain adjustment circuit that receives a signal based on an output of the variable gain unit and adjusts a gain of the variable gain unit. Used as the gain adjustment circuit here is the gain adjustment circuit described above. To achieve the second object, according to the present invention, an electric device is provided with the signal processing circuit according to the present invention (the signal processing circuit that is provided with a variable gain unit, a signal processor that processes a signal based on an output of the variable gain unit, and a gain adjustment circuit that receives a signal based on an output of the variable gain unit and adjusts a gain of the variable gain unit. Here, used as the gain adjustment circuit is the gain adjustment circuit described above).

### EFFECT OF THE INVENTION

According to the present invention, it is possible to realize a discrimination circuit that can discriminate between noise and a signal that is repeated with interposed rest time periods and that can achieve miniaturization, and a signal processing circuit and an electric device provided with such a discrimination circuit. Moreover, according to the present invention, it is possible to realize a gain adjustment circuit that achieves a high gain adjustment rate, and a signal processing circuit and an electric device provided with such a gain adjustment circuit.

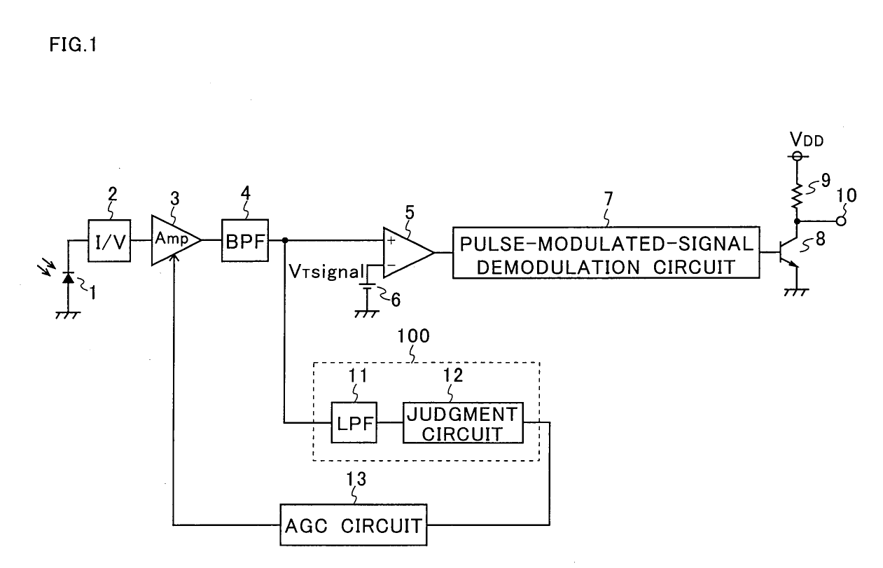

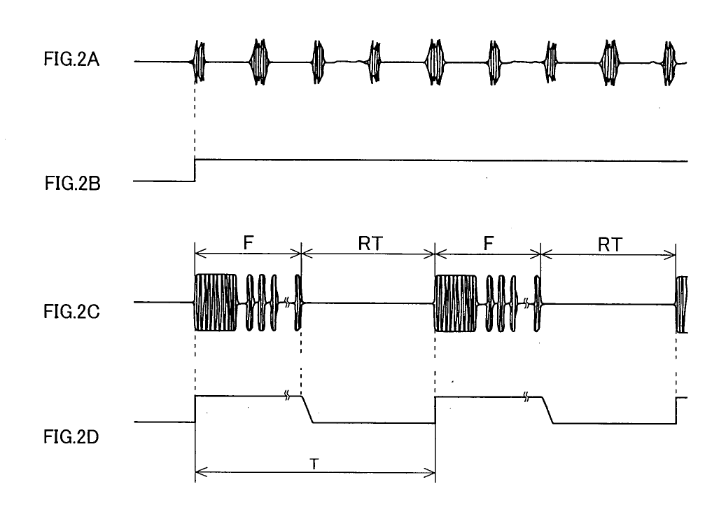

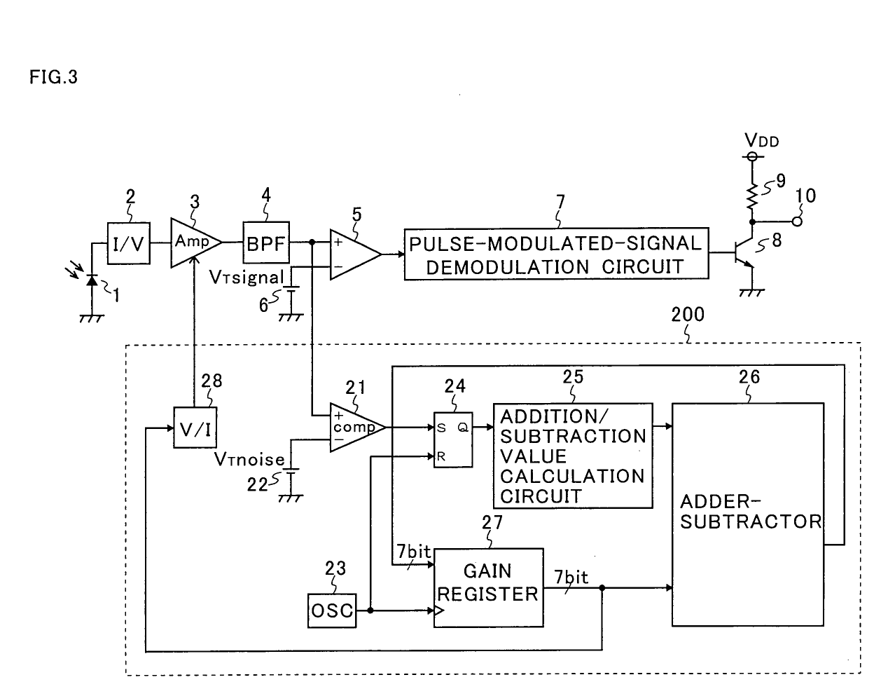

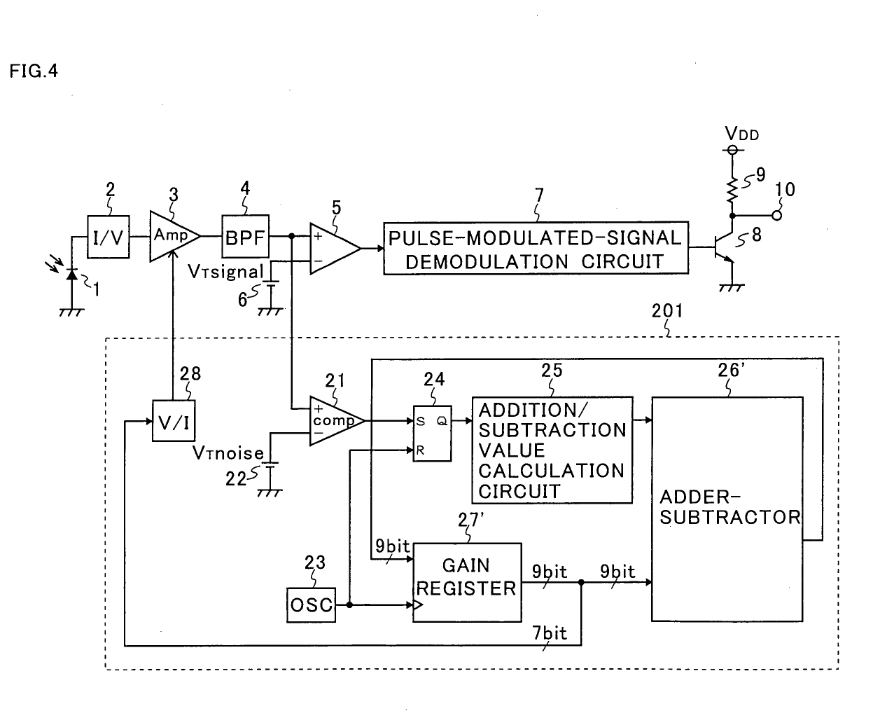

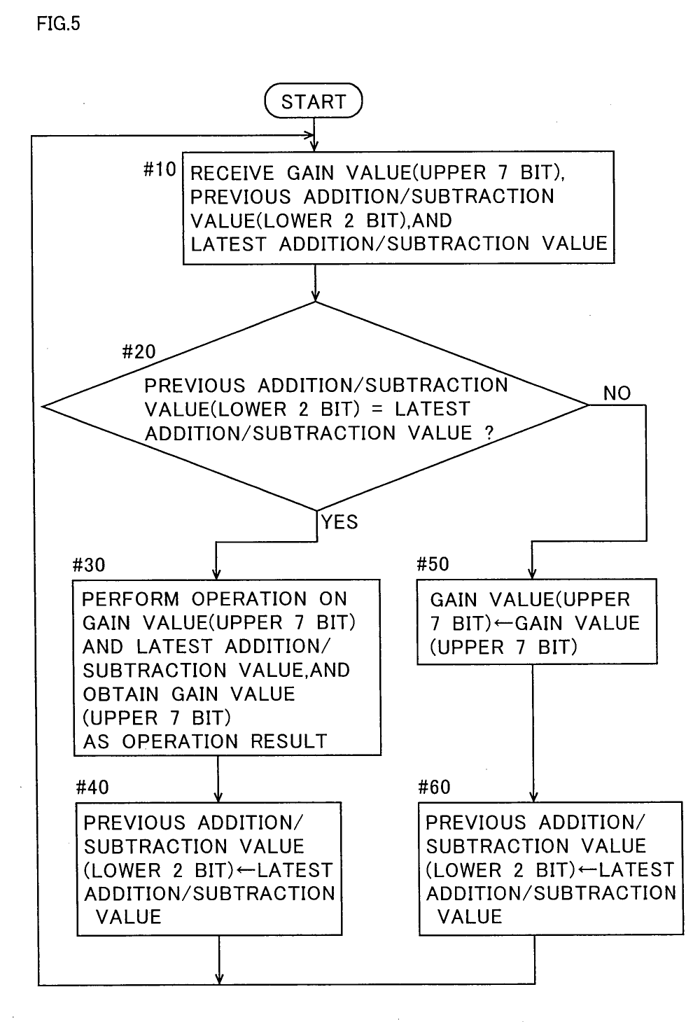

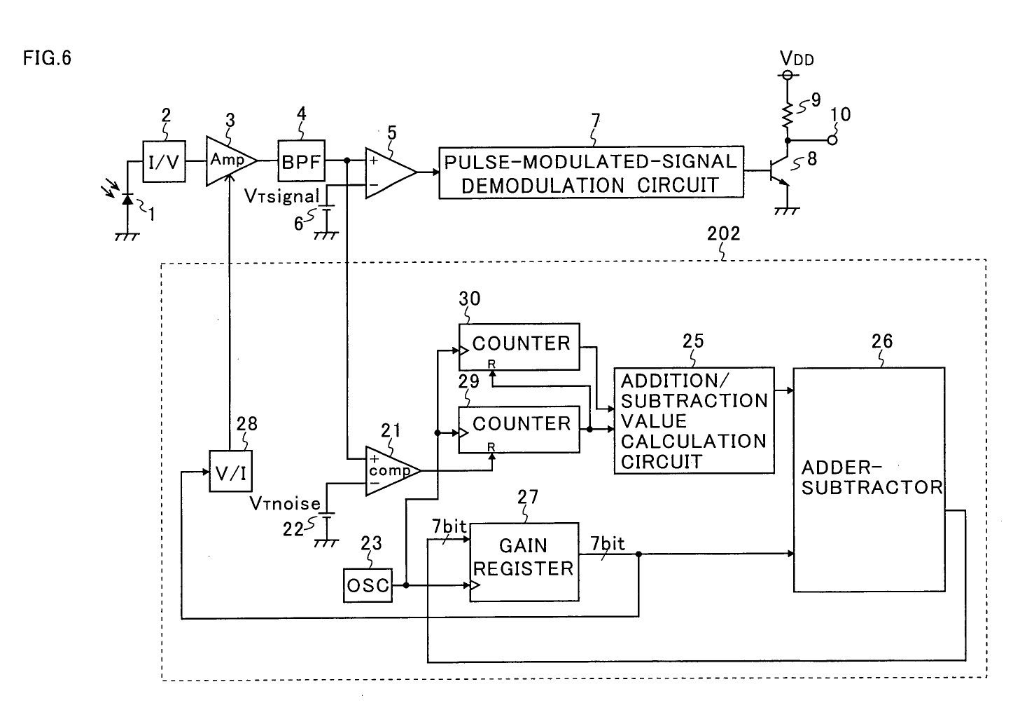

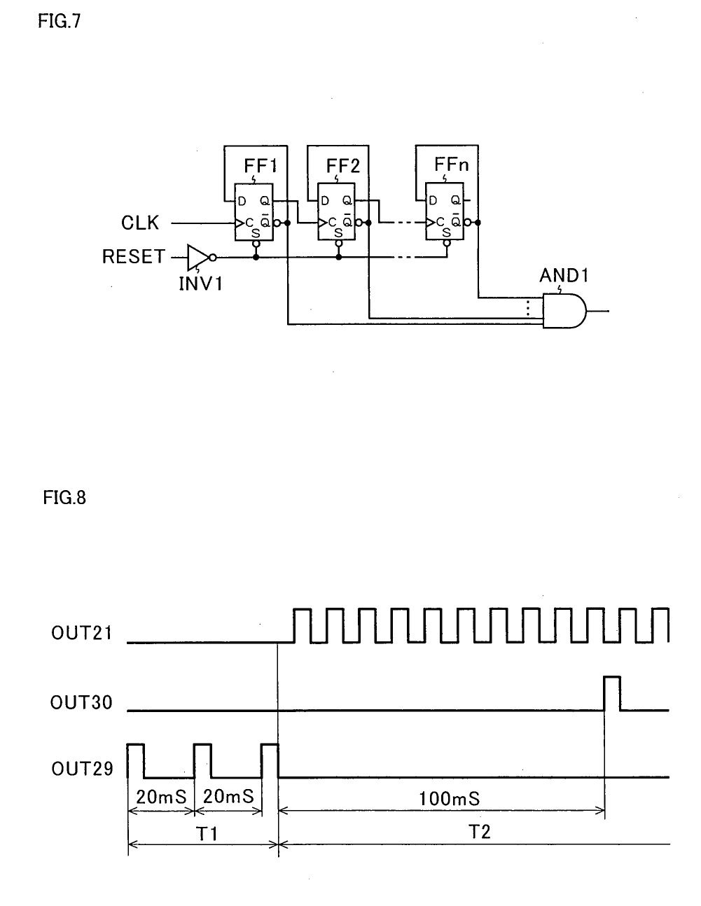

### BRIEF DESCRIPTION OF DRAWINGS

[FIG. 1] A diagram showing an example of the configuration of the photoreceiver circuit embodying the present invention.

[FIGS. 2A to 2D] Diagrams showing the signal waveforms of the relevant blocks of the photoreceiver circuit shown in FIG. 1 embodying the present invention.

[FIG. 3] A diagram showing another example of the configuration of the photoreceiver circuit embodying the present invention.

[FIG. 4] A diagram showing still another example of the configuration of the photoreceiver circuit embodying the present invention.

[FIG. 5] An operational flow chart of the adder-subtractor provided in the photoreceiver circuit shown in FIG. 4.

[FIG. 6] A diagram showing still another example of the configuration of the photoreceiver circuit embodying the present invention.

[FIG. 7] A diagram showing an example of the configuration of the counter provided in the photoreceiver circuit shown in FIG. 6.

[FIG. 8] A timing chart showing the outputs of the relevant blocks of the photoreceiver circuit shown in FIG. 6.

[FIG. 9] A diagram showing an example of a waveform of a signal that is repeated with long interposed rest time periods RT.

[FIG. 10] A diagram showing an example of a waveform of periodic noise.

[FIG. 11] A diagram showing a typical circuit configuration of a conventional photoreceiver circuit.

[FIG. 12] A diagram showing the signal waveforms of the relevant blocks of the conventional photoreceiver circuit shown in FIG. 11.

### LIST OF REFERENCE SYMBOLS

1 photodiode
2 current-voltage conversion circuit
3 variable gain amplifier, amplifier
4 band-pass filter
5 operational amplifier
6, 22 constant voltage source
7 pulse-modulated-signal demodulation circuit
8 transistor
9 pull-up resistor
10 output terminal
11 low-pass filter
12 judgment circuit
13 AGC circuit
21 comparator
23 oscillator
24 set-reset flip-flop
25 addition/subtraction value calculation circuit
26, 26′ adder-subtractor
27, 27′ gain register
28 voltage-current conversion circuit
100 discrimination circuit
200 to 202 gain adjustment circuit
AND1 AND circuit
FF1 to FFn flip-flop
INV1 inverter circuit

### BEST MODE FOR CARRYING OUT THE INVENTION

Hereinafter, an embodiment of the present invention will be described with reference to the drawings. Now, as a signal processing circuit of the present invention that is provided with a discrimination circuit that can discriminate between noise and a signal that is repeated with interposed rest time periods and that can achieve miniaturization, a photoreceiver circuit that receives an optical signal transmitted from an infrared remote control transmitter will be described. FIG. 1 shows an example of the configuration of the photoreceiver circuit of the present invention that is provided with a discrimination circuit that can discriminate between noise and a signal that is repeated with interposed rest time periods and that can achieve miniaturization. Note that, in FIG. 1, such members as are found also in FIG. 11 will be identified with common reference characters.

The photoreceiver circuit shown in FIG. 1 is composed of a photodiode 1, a current-voltage conversion circuit 2, a variable gain amplifier 3 whose gain is variable, a band-pass filter 4, an operational amplifier 5, a constant voltage source 6, a pulse-modulated-signal demodulation circuit 7, a transistor 8, a pull-up resistor 9, an output terminal 10, a discrimination circuit 100 that discriminates between noise and a signal that is repeated with interposed rest time periods, and a gain control circuit (hereinafter, an AGC (automatic gain control) circuit) 13 that controls a gain of the variable gain amplifier 3.

An optical signal transmitted from an infrared remote control transmitter (unillustrated) is converted into a current signal by the photodiode 1. The current signal is then converted into a voltage signal by the current-voltage conversion circuit 2. The resultant voltage signal is then amplified by the variable gain amplifier 3, and is then inputted to the band-pass filter 4.

The band-pass filter 4 allows only a frequency component of the received signal in a predetermined range to pass therethrough, and sends it to the non-inverting input terminal of the operational amplifier 5 and to the discrimination circuit 100.

The operational amplifier 5 amplifies a comparison result between an output signal of the band-pass filter 4 and a signal recognition level voltage V_{T}signal outputted from the constant voltage source 6, and then outputs it to the pulse-modulated-signal demodulation circuit 7.

The pulse-modulated-signal demodulation circuit 7 demodulates the pulse-modulated signal, the output signal of the operational amplifier 5, and outputs the demodulated signal to the base of the transistor 8. Here, the emitter of the transistor 8 is grounded, the collector of the transistor 8 is connected to the pull-up resistor 9, and the output terminal 10 is connected to a node where the collector of the transistor 8 and the pull-up resistor 9 are connected together. Thus, the signal outputted from the pulse-modulated-signal demodulation circuit 7 is inverted and then outputted from the output terminal 10. As described above, the photoreceiver circuit shown in FIG. 1 receives an optical signal, a pulse-modulated signal, and can output a code signal that takes a Low or High level on the occurrence or non-occurrence, respectively, of a pulse of the received optical signal.

The discrimination circuit 100 discriminates between noise contained in the output signal of the band-pass filter 4 and a signal that is also contained in that output signal and is repeated with interposed rest time periods, and outputs the discrimination result to the AGC circuit 13. If the discrimination circuit 100 finds it to be noise, the AGC circuit 13 reduces a gain of the variable gain amplifier 3; if the discrimination circuit 100 finds it to be a signal that is repeated with interposed rest time periods, the AGC circuit 13 increases a gain of the variable gain amplifier 3. This helps prevent noise from being higher than the signal recognition level V_{T}signal, thereby eliminating the possibility of a malfunction even if a signal outputted from the output terminal 10 is inputted, for example, to a microcomputer that cannot ignore (remove or cancel, for example) a pulse based on noise.

Now, the discrimination circuit 100, which is a distinctive feature of the photoreceiver circuit shown in FIG. 1, will be described in detail. The discrimination circuit 100 is composed of a low-pass filter 11 and a judgment circuit 12.

The low-pass filter 11 allows only a frequency component of the output signal of the band-pass filter 4 that is lower than a predetermined frequency (cut-off frequency) to pass therethrough, and sends it to the judgment circuit 12.

When a fluorescent lamp is lit and no optical signal is transmitted from the infrared remote control transmitter, as shown in FIG. 2A, the output signal of the band-pass filter 4 is composed entirely of noise at a frequency of 100 to 120 Hz that is produced when the fluorescent lamp is lit. On the other hand, when the fluorescent lamp is not lit and the optical signal is transmitted from the infrared remote control transmitter, as shown in FIG. 2C, the output signal of the band-pass filter 4 is composed entirely of the signal based on the optical signal transmitted from the infrared remote control transmitter.

The time constant of the low-pass filter 11 is determined in such a way that, when the output signal of the band-pass filter 4 has a waveform shown in FIG. 2A, the low-pass filter 11 outputs a signal that maintains a High level, as shown in FIG. 2B, and, when the output signal of the band-pass filter 4 has a waveform shown in FIG. 2C, the low-pass filter 11 outputs a signal in which a High level period corresponding to one frame F of the optical signal transmitted from the infrared remote control transmitter and a Low level period corresponding to a rest time period RT interposed between the frames of the optical signal transmitted from the infrared remote control transmitter appear alternately, as shown in FIG. 2D. Incidentally, a total time period T of the High level period and the Low level period of the signal shown in FIG. 2D is 100 to 150 mS.

When the High level period of the output signal of the low-pass filter 11 is longer than a predetermined time period (e.g. 150 ms), the discrimination circuit 12 finds the output signal of the band-pass filter 4 to be noise at a frequency of 100 to 120 Hz that is produced when the fluorescent lamp is lit; when the High level period of the output signal of the low-pass filter 11 is not longer than the predetermined time period, the discrimination circuit 12 finds the output signal of the band-pass filter 4 to be a signal that is repeated with interposed rest time periods. Increasing a gain in the Low level period of the output signal of the low-pass filter 11, that is, the rest time period RT of the signal, permits an average gain to be set higher at the time of signal input than at the time of no signal input. Thus, it is also possible to offer the noise removal effect by determining that noise occurs in the High level period of the output signal of the low-pass filter 11 and no noise occurs in the Low level period of the output signal of the low-pass filter 11.

Assume that, like a signal S4 shown in FIG. 12, the output signal of the band-pass filter 4 has, instead of the signal waveforms shown in FIGS. 2A and 2C, a noise pulse NP based on noise N at a frequency of 100 to 120 Hz that is produced when the fluorescent lamp is lit and a signal pulse SP based on a signal S based on an optical signal transmitted from the infrared remote control transmitter. Then, the output signal of the low-pass filter 11 behaves as shown in FIG. 2B if the gain of the variable gain amplifier 3 is high, and the discrimination circuit 100 checks whether it is noise or not. If the discrimination circuit 100 finds it to be noise, the AGC circuit 13 reduces the gain of the variable gain amplifier 3. This makes it possible to prevent the noise from being higher than the signal recognition level V_{T}signal.

The discrimination circuit 100 discriminates between noise and a signal that is repeated with interposed rest time periods based on the output waveform of the low-pass filter 11. This eliminates the need to provide a counter or the like, contributing to miniaturization of the circuit.

The above-described photoreceiver circuit shown in FIG. 1 can be incorporated in various electric devices (TVs, audiovisual apparatuses, and the like) provided with a controller that controls the entire device based on the signal outputted from the photoreceiver circuit. The embodiment described above deals with a photodiode as a photoreceptor; however, it is also possible to use instead other photoreceptors such as a photo transistor.

Hereinafter, a signal processing circuit embodying the present invention provided with a gain adjustment circuit that achieves a high gain adjustment rate, taking up as an example a photoreceiver circuit that receives an optical signal transmitted from an infrared remote control transmitter aimed at foreign manufacturers.

FIG. 3 shows an example of the configuration of the photoreceiver circuit embodying the present invention provided with a gain adjustment circuit that achieves a high gain adjustment rate. Note that, in FIG. 3, such members as are found also in FIG. 1 will be identified with common reference characters. The photoreceiver circuit shown in FIG. 3 is composed of a photodiode 1, a current-voltage conversion circuit 2, an amplifier 3 whose gain is variable, a band-pass filter 4, an operational amplifier 5, a constant voltage source 6, a pulse-modulated-signal demodulation circuit 7, a transistor 8, a pull-up resistor 9, an output terminal 10, and a gain adjustment circuit 200.

An optical signal transmitted from an infrared remote control transmitter (unillustrated) is converted into a current signal by the photodiode 1. The current signal is then converted into a voltage signal by the current-voltage conversion circuit 2, is then amplified by the amplifier 3, and is then inputted to the band-pass filter 4.

The band-pass filter 4 allows only a frequency component of the received signal in a predetermined range to pass therethrough, and sends it to the non-inverting input terminal of the operational amplifier 5 and to the gain adjustment circuit 200.

The operational amplifier 5 amplifies a comparison result between an output signal of the band-pass filter 4 and a signal recognition level voltage V_{T}signal outputted from the constant voltage source 6, and then outputs it to the pulse-modulated-signal demodulation circuit 7. As a result of the optical signal transmitted from the infrared remote control transmitter (unillustrated) to the photodiode 1 being a pulse-modulated signal, the output signal of the operational amplifier 5 is also a pulse-modulated signal. The pulse-modulated-signal demodulation circuit 7 demodulates the pulse-modulated signal, the output signal of the operational amplifier 5, and outputs the demodulated signal to the base of the transistor 8. The emitter of the transistor 8 is grounded, the collector of the transistor 8 is connected to the pull-up resistor 9, and the output terminal 10 is connected to a node where the collector of the transistor 8 and the pull-up resistor 9 are connected together. Thus, the signal outputted from the pulse-modulated-signal demodulation circuit 7 is inverted and then outputted from the output terminal 10.

The gain adjustment circuit 200 adjusts the gain of the amplifier 3 according to the output signal of the band-pass filter 4.

As described above, the photoreceiver circuit shown in FIG. 3 receives an optical signal, a pulse-modulated signal, and can output a code signal that takes a Low or High level on the occurrence or non-occurrence, respectively, of a pulse of the received optical signal. Moreover, the gain adjustment circuit 200, which will be described in detail later, adjusts the gain of the amplifier 3. This makes it possible to prevent the noise from being higher than the signal recognition level voltage V_{T}signal.

Now, the gain adjustment circuit 200, which is a distinctive feature of the photoreceiver circuit shown in FIG. 3, will be described in detail. The gain adjustment circuit 200 is composed of a comparator 21, a constant voltage source 22, an oscillator (OSC) 23, a set-reset flip-flop 24, an addition/subtraction value calculation circuit 25, an adder-subtractor 26, a gain register 27, and a voltage-current conversion circuit 28. As a result of the gain register 27, which temporarily stores a gain value, being a 7-bit register, the gain value can be adjusted in 128 levels.

The comparator 21 does not check whether an output signal of the band-pass filter 4 is a signal or noise. Instead, if the output signal of the band-pass filter 4 is found to be higher than a noise-level voltage V_{T}noise (<V_{T}signal) outputted from the constant voltage source 22, the comparator 21 outputs a signal that takes a High level to the set terminal of the set-reset flip-flop 24; if the output signal of the band-pass filter 4 is found not to be higher than the noise-level voltage V_{T}noise outputted from the constant voltage source 22, the comparator 21 outputs a signal that takes a Low level to the set terminal of the set-reset flip-flop 24.

The set-reset flip-flop 24 is reset by a clock signal generated by the oscillator 23 and having a predetermined period (which is longer than a period of noise but shorter than a rest time period RT shown in FIG. 9; in this embodiment, 20 mS) at intervals of that predetermined period.

If the set-reset flip-flop 24 outputs a High level, the addition/subtraction value calculation circuit 25 outputs a predetermined subtraction value (in this embodiment, −1); if the set-reset flip-flop 24 outputs a Low level, the addition/subtraction value calculation circuit 25 outputs a predetermined addition value (in this embodiment, 2). The adder-subtractor 26 performs an operation on a gain value (7-bit digital data) outputted from the gain register 27 and the subtraction or addition value outputted from the addition/subtraction value calculation circuit 25, and outputs an operation result to the gain register 27 as a gain value (7-bit digital data).

The gain register 27 performs clock operation at intervals of the predetermined period described above based on the clock signal generated by the oscillator 23. The gain value (7-bit digital data) outputted from the gain register 27 is outputted to the voltage-current conversion circuit 28 as well as to the adder-subtractor 26. The voltage-current conversion circuit 28 converts the gain value (7-bit digital data), the voltage signal, into an analog current signal, and varies the gain of the amplifier 3 based on the analog current signal thus obtained.

For example, assume that a signal shown in FIG. 9 is processed. Then, in the gain adjustment circuit 200 of the photoreceiver circuit shown in FIG. 3, the transition from the minimum gain to the maximum gain requires 1.27 S (=127×20 mS÷2 (addition value)), and the transition from the maximum gain to the minimum gain requires 2.54 S (=127×20 mS). On the other hand, when the technology disclosed in Patent Document 1 is used under the same conditions, the transition from the minimum gain to the maximum gain requires 12.7 S, and the transition from the maximum gain to the minimum gain requires 12.7 S. As described above, as compared with a case where the technology disclosed in Patent Document 1 is used, the gain adjustment circuit 200 of the photoreceiver circuit shown in FIG. 3 achieves a high gain adjustment rate. Thus, the photoreceiver circuit shown in FIG. 3 can deal with the sudden occurrence of noise (for example, when the fluorescent lamp is suddenly lit) more smoothly.

Moreover, the technology disclosed in Patent Document 1 requires a counter composed of a plurality of flip-flops that count a check time period Tcheck. In the gain adjustment circuit 200 of the photoreceiver circuit shown in FIG. 3, by contrast, there is provided, instead of a counter, a calculation circuit block (the addition/subtraction value calculation circuit 25 and the adder-subtractor 26) composed of a plurality of logic gates. When circuit size is compared, the calculation circuit block can reduce the circuit size more greatly than the counter. Thus, the gain adjustment circuit 200 of the photoreceiver circuit shown in FIG. 3 can achieve miniaturization and cost reduction.

The gain adjustment circuit 200 of the photoreceiver circuit shown in FIG. 3 does not discriminate between noise and a signal. Thus, if the photoreceiver circuit shown in FIG. 3 continuously receives a signal, as a result of the signal being higher than the noise-level voltage V_{T}noise, the gain of the amplifier 3 may drop to an undesired low level. However, there is a rest time period RT (see FIG. 9) between the signal time periods ST. Accordingly, so long as the desired gain is restored during the rest time period RT, this causes no problem. Preferably, the addition value is so set as to be larger than the absolute value of the subtraction value so as to ensure that the desired gain can be restored during the rest time period RT. The larger addition value ensures a higher probability of gain restoration. However, too large addition value may allow noise to be recognized as a signal. Thus, it is necessary to set an appropriate addition value.

Next, another example of the configuration of the photoreceiver circuit embodying the present invention provided with the gain adjustment circuit that achieves a high gain adjustment rate is shown in FIG. 4. Note that, in FIG. 4, such members as are found also in FIG. 3 will be identified with common reference characters and their detailed descriptions will be omitted. The photoreceiver circuit shown in FIG. 4 has a configuration in which the gain adjustment circuit 200 of the photoreceiver circuit shown in FIG. 3 is replaced with a gain adjustment circuit 201. The gain adjustment circuit 201 has a configuration in which the adder-subtractor 26 and the gain register 27 of the gain adjustment circuit 200 are replaced with an adder-subtractor 26′ and a gain register 27′.

Hereinafter, the gain adjustment circuit 201 will be described. The gain adjustment circuit 201 is composed of a comparator 21, a constant voltage source 22, an oscillator (OSC) 23, a set-reset flip-flop 24, an addition/subtraction value calculation circuit 25, an adder-subtractor 26′, a gain register 27′, and a voltage-current conversion circuit 28. As a result of the gain register 27′, which temporarily stores a gain value, being a 9-bit register and using upper 7 bits for temporarily storing a gain value, the gain value can be adjusted in 128 levels.

The comparator 21 does not check whether an output signal of the band-pass filter 4 is a signal or noise. Instead, if the output signal of the band-pass filter 4 is found to be higher than a noise-level voltage V_{T}noise (<V_{T}signal) outputted from the constant voltage source 22, the comparator 21 outputs a signal that takes a High level to the set terminal of the set-reset flip-flop 24; if the output signal of the band-pass filter 4 is found not to be higher than the noise-level voltage V_{T}noise outputted from the constant voltage source 22, the comparator 21 outputs a signal that takes a Low level to the set terminal of the set-reset flip-flop 24.

The set-reset flip-flop 24 is reset by a clock signal generated by the oscillator 23 and having a predetermined period (which is longer than a period of noise but shorter than a rest time period RT shown in FIG. 9; in this embodiment, 20 mS) at intervals of that predetermined period.

If the output of the set-reset flip-flop 24 takes a High level, the addition/subtraction value calculation circuit 25 outputs a predetermined subtraction value (in this embodiment, −1); if the output of the set-reset flip-flop 24 takes a Low level, the addition/subtraction value calculation circuit 25 outputs a predetermined addition value (in this embodiment, 2).

The adder-subtractor 26′ receives a gain value (upper-7-bit digital data) outputted from the gain register 27′, the previous addition/subtraction value (lower-2-bit digital data), and a subtraction or addition value (the latest addition/subtraction value) outputted from the addition/subtraction value calculation circuit 25 (step #10 in FIG. 5).

If the previous addition/subtraction value (lower-2-bit digital data) outputted from the gain register 27′ is equal to the subtraction or addition value (the latest addition/subtraction value) outputted from the addition/subtraction value calculation circuit 25 (YES in step #20 in FIG. 5), the adder-subtractor 26′ performs an operation on the gain value (upper-7-bit digital data) outputted from the gain register 27′ and the subtraction or addition value (the latest addition/subtraction value) outputted from the addition/subtraction value calculation circuit 25. The adder-subtractor 26′ outputs an operation result to the gain register 27′ as a gain value (upper-7-bit digital data) (step #30 in FIG. 5), and outputs, to the gain register 27′, the subtraction or addition value (the latest addition/subtraction value) outputted from the addition/subtraction value calculation circuit 25 as an addition/subtraction value (lower-2-bit digital data) to be stored (step #40 in FIG. 5). On the other hand, if the previous addition/subtraction value (lower-2-bit digital data) outputted from the gain register 27′ is not equal to the subtraction or addition value (the latest addition/subtraction value) outputted from the addition/subtraction value calculation circuit 25 (NO in step #20 in FIG. 5), the adder-subtractor 26′ outputs the gain value (upper-7-bit digital data) outputted from the gain register 27′, as it is, as a gain value (upper-7-bit digital data) to the gain register 27′ (step #50 in FIG. 5), and outputs, to the gain register 27′, the subtraction or addition value (the latest addition/subtraction value) outputted from the addition/subtraction value calculation circuit 25 as an addition/subtraction value (lower-2-bit digital data) to be stored (step #60 in FIG. 5).

The gain register 27′ performs clock operation at intervals of the predetermined period described above based on the clock signal generated by the oscillator 23. The gain value (upper-7-bit digital data) outputted from the gain register 27′ is outputted to the voltage-current conversion circuit 28 as well as to the adder-subtractor 26′. The voltage-current conversion circuit 28 converts the gain value (upper-7-bit digital data), the voltage signal, into an analog current signal, and varies the gain of the amplifier 3 based on the analog current signal.

The gain adjustment circuit 201 of the photoreceiver circuit shown in FIG. 4 obtains the same effects as the gain adjustment circuit 200 of the photoreceiver circuit shown in FIG. 3. Additionally, in the gain adjustment circuit 201, the gain value does not increase unless an addition value is continuously inputted to the adder-subtractor 26′, and the gain value does not decrease unless a subtraction value is continuously inputted to the adder-subtractor 26′. This makes it possible to suppress the variation of the gain value.

Next, still another example of the configuration of the photoreceiver circuit embodying the present invention provided with the gain adjustment circuit that achieves a high gain adjustment rate is shown in FIG. 6. Note that, in FIG. 6, such members as are found also in FIG. 3 will be identified with common reference characters and their detailed descriptions will be omitted. The photoreceiver circuit shown in FIG. 6 has a configuration in which the gain adjustment circuit 200 of the photoreceiver circuit shown in FIG. 3 is replaced with a gain adjustment circuit 202. The gain adjustment circuit 202 has a configuration in which the set-reset flip-flop 24 of the gain adjustment circuit 200 is replaced with counters 29 and 30.

Hereinafter, the gain adjustment circuit 202 will be described. The gain adjustment circuit 202 is composed of a comparator 21, a constant voltage source 22, an oscillator (OSC) 23, an addition/subtraction value calculation circuit 25, an adder-subtractor 26, a gain register 27, a voltage-current conversion circuit 28, counters 29 and 30. As a result of the gain register 27, which temporarily stores a gain value, being a 7-bit register, the gain value can be adjusted in 128 levels.

The comparator 21 does not check whether an output signal of the band-pass filter 4 is a signal or noise. Instead, if the output signal of the band-pass filter 4 is found to be higher than a noise-level voltage V_{T}noise (<V_{T}signal) outputted from the constant voltage source 22, the comparator 21 outputs a signal that takes a High level to the reset terminal of the counter 29; if the output signal of the band-pass filter 4 is found not to be higher than the noise-level voltage V_{T}noise outputted from the constant voltage source 22, the comparator 21 outputs a signal that takes a Low level to the reset terminal of the counter 29. An output of the counter 29 is sent to the reset terminal of the counter 30 and to the addition/subtraction value calculation circuit 25. An output of the counter 30 is sent to the addition/subtraction value calculation circuit 25.

The counters 29 and 30 perform counter operation based on a clock signal generated by the oscillator 23. As shown in FIG. 7, for example, the counters 29 and 30 may be each composed of a plurality of flip-flops FF1 to FFn, an inverter circuit INV1, and an AND circuit AND1.

Unless reset, the counter 29 outputs a pulse at a predetermined time interval (in this embodiment, 20 mS) that is longer than a period of noise but shorter than a rest time period RT shown in FIG. 9. The counter 29 is reset when an output of the comparator 21 takes a High level. Unless reset, the counter 30 outputs a pulse at intervals of time (in this embodiment, 100 mS) corresponding to the sum of a signal-generating time period ST and a rest time period RT shown in FIG. 9. Upon receiving a pulse output from the counter 29, the counter 30 is reset.

Thus, when there is no signal, a timing chart of an output OUT21 of the comparator 21, an output OUT30 of the counter 30, and an output OUT29 of the counter 29 is as shown in FIG. 8. In FIG. 8, T1 represents a period in which no noise occurs, and T2 represents a period in which noise occurs.

Upon receiving a pulse output from the counter 30, the addition/subtraction value calculation circuit 25 outputs a predetermined subtraction value (in this embodiment, −1); upon receiving a pulse output from the counter 29, it outputs a predetermined addition value (in this embodiment, 1). The adder-subtractor 26 performs an operation on a gain value (7-bit digital data) outputted from the gain register 27 and the subtraction or addition value outputted from the addition/subtraction value calculation circuit 25, and outputs an operation result to the gain register 27 as a gain value (7-bit digital data).

The gain register 27 performs clock operation at intervals of the predetermined period described above based on a clock signal generated by the oscillator 23. The gain value (7-bit digital data) outputted from the gain register 27 is outputted to the voltage-current conversion circuit 28 as well as to the adder-subtractor 26. The voltage-current conversion circuit 28 converts the gain value (7-bit digital data), the voltage signal, into an analog current signal, and varies the gain of the amplifier 3 based on the analog current signal thus obtained.

For example, assume that a signal shown in FIG. 9 is processed. Then, in the gain adjustment circuit 202 of the photoreceiver circuit shown in FIG. 6, the transition from the minimum gain to the maximum gain requires 2.54 S (=127×20 mS), and the transition from the maximum gain to the minimum gain requires 12.7 S (=127×100 mS). On the other hand, when the technology disclosed in Patent Document 1 is used under the same conditions, the transition from the minimum gain to the maximum gain requires 12.7 S, and the transition from the maximum gain to the minimum gain requires 12.7 S. As described above, as compared with a case where the technology disclosed in Patent Document 1 is used, the gain adjustment circuit 202 of the photoreceiver circuit shown in FIG. 6 achieves a high gain adjustment rate in increasing a gain. Moreover, by setting the addition value to a value larger than the absolute value of the subtraction value, it is possible to further increase a gain adjustment rate in increasing a gain.

The photoreceiver circuit shown in FIG. 6 may be modified in a manner similar to that used when the photoreceiver circuit shown in FIG. 3 is modified to the photoreceiver circuit shown in FIG. 4. With such modification, it is possible to suppress the variation of the gain value.

The photoreceiver circuits embodying the present invention as shown in FIGS. 3, 4, and 6 can be incorporated in various electric devices (TVs, audiovisual apparatuses, and the like) provided with a controller that controls the entire device based on the signal outputted from the photoreceiver circuit. The embodiment described above deals with a photodiode as a photoreceptor; however, it is also possible to use instead other photoreceptors such as a photo transistor. Various set values (the number of gain levels, the value of a signal-generating time period ST, the value of a rest time period RT, the addition value, the subtraction value, and the like) are not limited to those used in the embodiment described above.

### INDUSTRIAL APPLICABILITY

The discrimination circuit of the present invention and the gain adjustment circuit of the present invention can each be applied to signal processing circuits (for example, photoreceiver circuits). The above-described photoreceiver circuits can be incorporated in various electric devices (TVs, audiovisual apparatuses, and the like) provided with a controller that controls the entire device based on the signal outputted from the photoreceiver circuit.

1. A discrimination circuit comprising a low-pass filter and a judgment circuit,
the discrimination circuit checking whether a received signal is noise or a signal that is repeated with interposed predetermined time periods, wherein
the low-pass filter has a cut-off frequency that is lower than a frequency of the noise but higher than a reciprocal of a total period of one frame of the signal that is repeated with interposed predetermined time periods and the predetermined time period, and
the judgment circuit judges, according to an output of the low-pass filter, whether the received signal is noise or a signal that is repeated with interposed predetermined time periods.

2. A signal processing circuit comprising:
a variable gain unit;
a discrimination circuit that receives a signal based on an output of the variable gain unit and checks whether the received signal is noise or a signal that is repeated with interposed predetermined time periods; and
a gain control circuit that controls a gain of the variable gain unit according to a check result of the discrimination circuit, wherein
the discrimination circuit has a low-pass filter and a judgment circuit,
the low-pass filter has a cut-off frequency that is lower than a frequency of the noise but higher than a reciprocal of a total period of one frame of the signal that is repeated with interposed predetermined time periods and the predetermined time period, and
the judgment circuit judges, according to an output of the low-pass filter, whether the received signal is noise or a signal that is repeated with interposed predetermined time periods.

3. The signal processing circuit of claim 2, further comprising:
a band-pass filter that receives a signal based on an output signal of the variable gain unit, wherein
the discrimination circuit receives a signal based on an output signal of the band-pass filter.

4. The signal processing circuit of claim 3, further comprising:
a signal processor that processes a signal based on the output signal of the band-pass filter.

5. An electric device comprising a signal processing circuit, wherein
the signal processing circuit includes
a variable gain unit,
a discrimination circuit that receives a signal based on an output of the variable gain unit and checks whether the received signal is noise or a signal that is repeated with interposed predetermined time periods, and
a gain control circuit that controls a gain of the variable gain unit according to a check result of the discrimination circuit,
the discrimination circuit includes a low-pass filter and a judgment circuit,
the low-pass filter has a cut-off frequency that is lower than a frequency of the noise but higher than a reciprocal of a total period of one frame of the signal that is repeated with interposed predetermined time periods and the predetermined time period, and
the judgment circuit judges, according to an output of the low-pass filter, whether the received signal is noise or a signal that is repeated with interposed predetermined time periods.

6. The electric device of claim 5, wherein
the signal processing circuit further includes a band-pass filter that receives a signal based on an output signal of the variable gain unit, and
the discrimination circuit receives a signal based on an output signal of the band-pass filter.

7. The electric device of claim 6, wherein
the signal processing circuit includes a signal processor that processes a signal based on an output signal of the band-pass filter.

8. A gain adjustment circuit comprising:
a comparison circuit that compares a received signal with a predetermined noise-level voltage;
an addition/subtraction value calculation circuit that outputs, according to a signal based on an output of the comparison circuit, a predetermined addition value or a predetermined subtraction value;
a gain register that temporarily stores a gain value;
an adder-subtractor that performs an operation on the predetermined addition value or the predetermined subtraction value outputted from the addition/subtraction value calculation circuit and the gain value outputted from the gain register, and outputs an operation result to the gain register as the gain value; and
a gain controller that adjusts a gain of an external variable gain unit according to a gain value outputted from the gain register.

9. The gain adjustment circuit of claim 8, further comprising:
an oscillator that generates a clock signal having a predetermined period; and
a set-reset flip-flop that receives an output of the comparison circuit at a set terminal thereof, that receives the clock signal at a reset terminal thereof, and that sends output data to the addition/subtraction value calculation circuit, wherein
the gain register performs, based on the clock signal, clock operation.

10. The gain adjustment circuit of claim 8, further comprising:
an oscillator that generates a clock signal;
a first counter that receives an output of the comparison circuit at a reset terminal thereof, and, unless reset, outputs a pulse at a first time interval; and
a second counter that receives an output of the first counter at a reset terminal thereof, and, unless reset, outputs a pulse at a second time interval, wherein
the gain register, the first counter, and the second counter operate based on the clock signal, and
upon receiving a pulse output from the second counter, the addition/subtraction value calculation circuit outputs a predetermined subtraction value, and, upon receiving a pulse output from the first counter, the addition/subtraction value calculation circuit outputs a predetermined addition value.

11. The gain adjustment circuit of claim 8, wherein
the predetermined addition value is larger than an absolute value of the predetermined subtraction value.

12. The gain adjustment circuit of claim 8, further comprising:
a storage portion that temporarily stores a previous predetermined addition value or predetermined subtraction value, wherein
if the previous predetermined addition value or predetermined subtraction value stored in the storage portion is not equal to the predetermined addition value or predetermined subtraction value outputted from the addition/subtraction value calculation circuit, the adder-subtractor outputs the gain value outputted from the gain register, as it is, as a gain value to the gain register without performing an operation on the predetermined addition value or the predetermined subtraction value outputted from the addition/subtraction value calculation circuit and the gain value outputted from the gain register.

13. A signal processing circuit comprising:
a variable gain unit;
a signal processor that processes a signal based on an output of the variable gain unit, and
a gain adjustment circuit that receives a signal based on an output of the variable gain unit and adjusts a gain of the variable gain unit, wherein
the gain adjustment circuit includes
a comparison circuit that compares a received signal with a predetermined noise-level voltage,
an addition/subtraction value calculation circuit that outputs a predetermined addition value or a predetermined subtraction value according to a signal based on an output of the comparison circuit,
a gain register that temporarily stores a gain value,
an adder-subtractor that performs an operation on the predetermined addition value or the predetermined subtraction value outputted from the addition/subtraction value calculation circuit and the gain value outputted from the gain register, and outputs an operation result to the gain register as the gain value, and
a gain controller that adjusts a gain of an external variable gain unit according to the gain value outputted from the gain register.

14. An electric device comprising a signal processing circuit, wherein
the signal processing circuit includes
a variable gain unit,
a signal processor that processes a signal based on an output of the variable gain unit, and
a gain adjustment circuit that receives a signal based on an output of the variable gain unit and adjusts a gain of the variable gain unit, and
the gain adjustment circuit includes
a comparison circuit that compares a received signal with a predetermined noise-level voltage,
an addition/subtraction value calculation circuit that outputs a predetermined addition value or a predetermined subtraction value according to a signal based on an output of the comparison circuit,
a gain register that temporarily stores a gain value,
an adder-subtractor that performs an operation on the predetermined addition value or the predetermined subtraction value outputted from the addition/subtraction value calculation circuit and the gain value outputted from the gain register, and outputs an operation result to the gain register as the gain value, and
a gain controller that adjusts a gain of an external variable gain unit according to the gain value outputted from the gain register.
